(19) United States
(12) Patent Application Publication
(10) Pub. No.: US 2010/0278995 A1
(43) Pub. Date: Nov. 4, 2010

(54) INSTANT BEVERAGE PRODUCT

(75) Inventors: Robert Thomas Boehm, Marysville, OH (US); Daniel Paul Donhowe, Dublin, OH (US); Patricia Ann Mathias, Dublin, OH (US); Xiaoping Fu, Dublin, OH (US); Joseph Bernard Rechtiene, Villars-le-Terroir (CH); Ulrich Kessler, Savigny (CH); Mathalai Balan Sudharsan, Lausanne (CH)

Correspondence Address: K&L Gates LLP, P.O. Box 1135, CHICAGO, IL, 60690, US

(73) Assignee: Nestec S.A., Vevey (CH)

(21) Appl. No.: 12/809,882

(22) PCT Filed: Dec. 16, 2008
(86) PCT No.: PCT/EP2008/067575

§ 371 Date: Jun. 21, 2010

Related U.S. Application Data
(60) Provisional application No. 61/015,541, filed on Dec. 20, 2007.

(51) Int. Cl. A23F 5/30; A23C 1/08; A23L 2/00; A23L 2/12; A23F 5/38; A23C 9/16; A23P 1/06

(52) U.S. Cl. 426/590; 426/385; 426/506; 426/507

(57) ABSTRACT

The present invention relates to a method for the production of instant beverage granules which, upon reconstitution with water, form a foamy upper surface. The method makes use of a porous base powder to which the present invention also relates.

### FIELD OF THE INVENTION

The present invention relates to a method for the production of instant beverage powders which, upon reconstitution with water, form a foamy upper surface. The method makes use of a porous base powder to which the present invention also relates.

### BACKGROUND OF THE INVENTION

In general, instant beverages are used to describe products such as tea, coffee or the like which are sold in a form that is easily reconstitutable with water to form a drink. Such beverages are typically in solid form and are readily soluble in hot water.

Instant soluble coffee is a phrase used to describe coffee which has been prepared by extraction of roast and ground coffee followed typically by reconstitution of the extract into a powdered product by conventional means such as freeze-drying, spray-drying or the like.

In order to prepare a beverage, hot water is then simply added to the powder thus avoiding the complicated and time-consuming process which is involved when preparing a beverage from traditional roast and ground coffee.

However, unlike coffee beverages prepared from roast and ground coffee, those prepared from instant soluble coffee do not usually exhibit a fine foam on their upper surface when reconstituted with hot water.

The foamed upper surface in beverages prepared from roast and ground coffee are typically associated with and caused, at least in part, by the machines which brew with pressurised water and/or steam.

This foam is known to positively affect the mouthfeel of the product when consumed and so is highly desired by many consumers. Furthermore, the foam acts to keep more of the volatile aromas within the beverage so that they can be appreciated by the consumer rather than lost to the surrounding environment.

Nevertheless, instant beverages such as instant soluble coffee are not suited for use with roast and ground coffee brewing apparatus and so the solution for foaming the beverage derived from roast and ground coffee is not readily applicable to instant beverages.

Instead, the foam must be generated by simple admixing of the instant beverage product and a liquid.

U.S. Pat. No. 6,713,113 discloses a powdered soluble foaming ingredient which has a matrix containing a carbohydrate, a protein and entrapped pressurized gas. The gas is released upon addition of the dry powder to liquid.

U.S. Pat. No. 4,830,869 and U.S. Pat. No. 4,903,585, both to Wimmers, et al. disclose a method for making a coffee beverage having a thick layer of foamed coffee on its surface, similar in appearance to cappuccino coffee. A measured amount of spray-dried instant coffee and a small amount of cold water are combined with vigorous agitation to form a foamed coffee concentrate. Then, hot water is added to make a coffee beverage.

U.S. Pat. No. 4,618,500 to Forquer discloses a method for preparing a brewed espresso-type coffee beverage which has froth on the surface of the beverage. Steam is injected into the brewed coffee beverage to produce the froth.

U.S. Pat. No. 3,749,378 to Rhodes discloses an apparatus for foaming a coffee extract. Gas is introduced into the coffee extract and the foamed coffee is then spray-dried to make a soluble coffee product having a low bulk density.

A similar process is described in EP 0 839 457 B1 to Kraft Foods, whereby the soluble coffee powder is foamed by gas injection. The gas bubbles size is then reduced such that the final product will have gas bubbles of less than 10 micrometres.

Many instant foamed beverages are still lacking insofar as the foam initially produced is not conserved during consumption or the structure resembles a coarse foam rather than a fine and smooth (velvety) foam, ultimately desired by consumers. Alternatively or additionally, there may simply be insufficient foam produced.

It has now been found that powders with a certain microstructure enable the production of an instant beverage product which provides excellent foam and dissolution upon reconstitution in a liquid.

It has also been found that a process to produce a precursor with a certain microstructure and agglomeration of said precursor under specific conditions enables the production of an instant beverage product which provides excellent foam upon reconstitution with water.

Agglomeration of food products by sintering is known. For instance, U.S. Pat. No. 6,497,911 to Niro, refers to a process of preparing a water soluble coffee or tea product using a non-rewetted particulate material obtained from an extract by drying. During the process, external compaction of the product is required resulting in a product which suffers from structural collapse of the internal pores.

U.S. Pat. No. 5,089,279 to Conopco relates to a sintering process which is performed in a closed container so as not to lose humidity during sintering. This is suitable for confectionery, for instance, as it results in a sintered mass.

U.S. Pat. No. 4,394,395 to Nestlé describes a process for manufacturing a food product where a powder is filled into moulds, lightly compressed and then heated to sinter the powder. This results in a moulded food product.

U.S. Pat. No. 3,592,659 to General Foods Corporation describes a method of agglomerating frozen particles which can be used in the manufacture of instant coffee. Reconstitution of these agglomerates is however said to generate less foam than standard spray-dried coffee.

U.S. Pat. No. 3,573,060 to Hills Bros. Coffee relates to a freeze-dried coffee extract which is highly porous and is produced by shock-freezing coffee extract droplets and then freeze-drying them.

DE 19750679 to Windhab et al. relates to water/oil or water/oil/water emulsions which are spray frozen and sintered in order to improve their storage at low temperature.

A process for spray-freezing liquid products such as milk, coffee, fruit juices is also described in U.S. Pat. No. 3,670,520 to Bonteil et al.

A drying process whereby liquid substances such as fruit juice, pharmaceuticals, nutraceuticals, tea and coffee are spray freeze-dried is also described in WO2005/105253 to Agresearch Limited.

However, the above disclosures do not give a product having the desired porosity characteristics required for foaming upon reconstitution with water.

Furthermore, agglomeration using a sintering process is known to cause the partial or complete collapse of the microstructure (pores) in the product within which gas would be held. This problem needs to be addressed in order to provide a beverage having a desirable foamed upper surface.

Therefore, the present invention thus seeks to provide a beverage powder, which upon reconstitution yields a beverage with a desirable foamed upper surface.

### SUMMARY OF THE INVENTION

The object of the invention is solved by the independent claims. The dependent claims further develop the central idea of the invention.

Thus, in a first aspect is provided a method for the preparation of an instant beverage powder comprising the steps of
a. Providing a porous base powder
b. Sintering the base powder at a temperature below 0° C. to form a sintered cake
c. Grinding the sintered cake to provide a powder
d. Freeze-drying the powder to provide said instant beverage powder.

An instant beverage powder obtainable by said method is also part of the present invention.

In a further aspect, the present invention relates to a porous spray-frozen powder comprising a particle porosity of at least 35%, an ice crystal pore volume of less than 2.5 mL/g and an ice crystal pore size of less than 3 micrometres.

An instant beverage powder obtainable by cold sintering a powder according to any of claims 17 to 25 also relates to the present invention.

According to a further aspect of the invention, a sintered instant beverage powder having a foaming porosity of at least 35%, wherein the powder comprises ice sublimation voids is provided.

Similarly, a cold-sintered instant beverage powder comprising ice crystal sublimation voids throughout the volume of the powder particles is also part of the invention.

Another aspect of the invention concerns a method for the preparation of an instant beverage comprising the step of reconstituting an instant beverage powder according to any of claims 16 or 27 to 34 in a liquid.

### BRIEF DESCRIPTION OF THE FIGURES

The present invention is further described hereinafter with reference to some of its embodiments shown in the accompanying drawings in which:

FIG. 1 is a SEM (scanning electron micrograph) image of a sintered sample according to the invention, wherein the interparticle void (1), the cavity left by ice crystals after freeze-drying (2), and the gas pore formed during spray-drying (3) are apparent.

FIG. 2 is a SEM image of a sintered granule wherein the agglomeration of base powder particles is apparent.

FIG. 3 is a SEM image wherein the cavity left by ice crystals after freeze-drying (2), and the gas pore formed during spray-freezing (3) are apparent.

FIG. 4 is a graph comparing the open pore volume of commercial freeze-dried coffee (FD) and of the product of the invention (PI).

FIG. 5 is an SEM image of a freeze-dried spray-frozen powder according to the invention.

FIG. 6 is a representation of the process for the production of spray-frozen particles according to the present invention, wherein 6.1 is typically a coffee liquor, 6.2 represents gas injection, 6.3 is mixing device, 6.4 is a heat exchanger, 6.5 is a pump, 6.6 shows the transport of the foamed liquor prior to spraying and 6.7 shows the spray freezing chamber.

FIG. 7 is a schematic representation of a granule according to the present invention, which shows the granule (1) comprising closed pores (2), open pores with an opening diameter greater than 2 micrometres (3) and open pores with an opening diameter less than 2 micrometres (4).

FIG. 8 is a description of the equipment used to measure the crema volume of the samples, wherein (8.1) is a plastic scale for reading the foam volume, (8.2) is a water reservoir, (8.3) is the lid of the reconstitution vessel, (8.4) is a connection valve, (8.5) is the reconstitution vessel and (8.6) is the release valve.

### DETAILED DESCRIPTION OF THE INVENTION

The present invention relates to the manufacture of instant beverage powder. By “instant beverage” is meant any beverage which can be reconstituted by addition of liquid, e.g. hot water. Such beverage may be coffee, tea, juice, milk shake etc.

The present invention relates to instant beverage powders which deliver an excellent foamed upper surface (also called “crema”) upon reconstitution with a liquid which confers to the product advantageous organoleptic properties.

In one embodiment of the invention, the instant beverage powder is in the form of granules. In the following the term “granule” is used to describe a powder which may be obtainable by agglomeration of smaller powder particles. The granules thus comprise smaller constitutive powder particles. These smaller constitutive powder particles may be partially fused to form the bigger granules.

In the present application, the term “powder” is used interchangeably with “granules” and is used to define the sintered instant beverage powders of the present invention and the finer powders which are used in the production of said sintered powders. Which definition is to be understood is clear from the context.

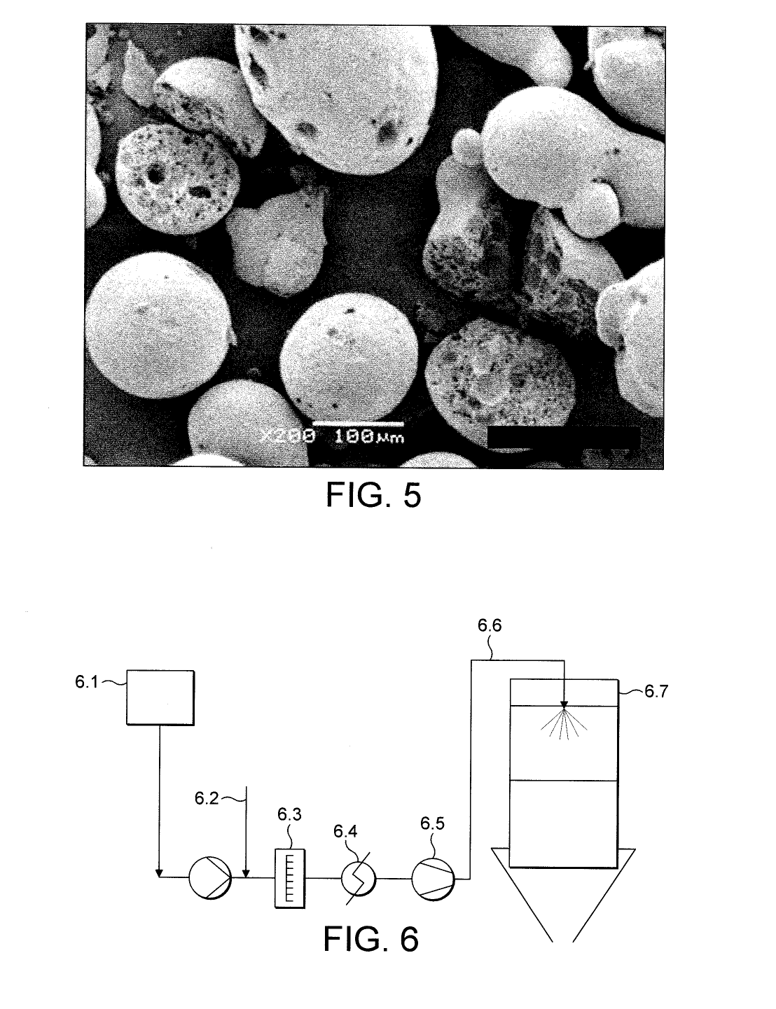

Thus, the present invention relates to a method for the manufacture of instant beverage powder which comprises, in a first step, the provision of a porous base powder. Preferably, the porous base powder is a spray-frozen powder. Such a powder is illustrated in FIG. 5.

Spray-freezing is a technology which has been known for many years. It consists in spraying a liquid into droplets and simultaneously freezing said droplets.

In the present invention, the spray-freezing may be carried out according to a process schematised in FIG. 6. The liquid to be spray-frozen may be any beverage, preferably it is a coffee extract (6.1). The coffee extract preferably comprises a solids content above 40%, more preferably above 50%. The coffee extract is firstly subjected to the addition of a gas (6.2), preferably nitrogen, by the means of a sparging device distributing the nitrogen homogeneously. The gas may be added before or after the high pressure pump. Preferably, a mixing device (6.3) is used in order to ensure a homogeneous dispersion of the gas bubbles. In a preferred embodiment, a heat exchanger (6.4) is used in order to cool the foamed extract after gas injection. The temperature of the extract should be brought to between 0 and 60° C., preferably between 0 to 30° C., such as between 10 and 25° C. or between 15 and 30° C. The foamed extract then enters a high pressure pump (6.5) or homogeniser. Thus, the pressure of the extract may be increased to 65 to 400 bar, preferably 85 to 250 bar. The foamed extract (6.6) is then pumped to the top of a spray-freezing tower (6.7), where the extract is atomised. The known spray-freezing process may be carried out by means of direct or indirect contact with cryogenic fluids such as liquid nitrogen, cold air, and liquid carbon dioxide.

This process results in a porous spray-frozen powder which can be used as a basis for the manufacture of instant beverage granules according to the present invention. Alternatively, the spray-frozen powder may be directly freeze-dried to yield a porous particulate powder which may be used in instant beverage applications, for example as an instant beverage powder.

The porous spray-frozen powder of the present invention comprises a particle porosity of at least 35%, an ice crystal pore volume of less than 2.5 mL/g, preferably less than 2.0 mL/g, and an ice crystal pore size of less than 3 micrometres, preferably between 0.1 and 3 micrometres.

Preferably, the particle porosity is between 35% and 85%, more preferably between 45% and 70%.

Porosity of the particles may be determined by techniques known to the skilled person such as mercury porosimetry, etc. Similarly ice crystal pore volume and ice crystal pore size may be measured by mercury porosimetry and SEM.

Preferably, the spray-frozen powder comprises an average pore size diameter D₅₀ of less than 40 micrometres, preferably less than 25 micrometres.

The pore size distribution of the spray-frozen powder of the invention may be characterised by a distribution span factor of less than 4, preferably less than 3, more preferably less than 2, most preferably less than 1. The distribution span factor is obtained by X-ray tomography. The span of the distribution is calculated by the following equation:

$$Span = \frac{{D}_{90} - {D}_{10}}{{D}_{50}}$$

wherein D₉₀, D₁₀ and D₅₀ represent respectively the equivalent pore size comprising 90%, 10% and 50% of the above mentioned pore size distribution. The pore size distribution is based on the void volume distribution. Thus, the lower the span factor, the more narrow and homogeneous the distribution of the pores.

The porous spray-frozen powder of the invention is further characterised by a tapped density between 150-650 g/L. The porous spray-frozen base powder preferable has a particle size (D₅₀) between 50 and 300 micrometres, more preferably between 100 and 200 micrometres.

The porous base powder is then used in a further sintering step according to the method of the present invention. Sintering is carried out at a temperature below 0° C. to form a sintered cake.

According to an embodiment, the porous base powder, which is preferably spray-frozen, is maintained at a temperature below 0° C. prior to sintering. Preferably, it is maintained at a temperature below −15° C., more preferably below −30° C. It is then transferred to a conveyer belt which passes through a sintering zone. Ideally, the base powder is conveyed in a continuous fashion into a feeder/distributor from which it is distributed onto the conveyer belt. The conveyer belt thus transports a bed of base powder particles loosely packed together. Preferably, no compaction of the bed is carried out prior to sintering.

The temperature of the sintering zone is below 0° C., preferably between −10 and −30° C. Preferably, the temperature of the sintering zone is higher than the temperature of the porous particles. The residence time in the sintering zone may be less than four hours, preferably less than one hour.

The base powder particles, when entering the sintering zone, are heated to a temperature above their glass transition, at which point they begin to fuse together. The degree of sintering, or fusion, increases with the residence time and temperature within the sintering zone. It is preferable to control the sintering to the point at which the particles are sufficiently fused together to maintain a strong enough product texture, but not over-sintered at which point the internal microstructure collapses and the gas volume (responsible for crema formation) is lost. As the particles fuse together and collapse, the volume of the interparticle voids in the final product (i.e. the void space between individual base powder particles) begins to decrease, which inhibits dissolution in the final product.

After sintering, the sintered cake is preferably passed through a cooling zone. The cooling zone is at a temperature below the sintering zone temperature. Typically the cooling zone is at a temperature below −10° C., preferably below −20° C., more preferably below −30° C.

Upon grinding, the sintered cake is formed into granules, typically having a size greater than 0.5 mm, preferably less than 4 mm.

After grinding, the granules are freeze-dried using standard methods. The moisture content of the granules after freeze-drying is typically 0.5-5%, such as 0.5-4%.

In an embodiment of the invention, all steps of the method may be carried out in a cold room environment at below 0° C., preferably below −15° C., more preferably below −30° C.

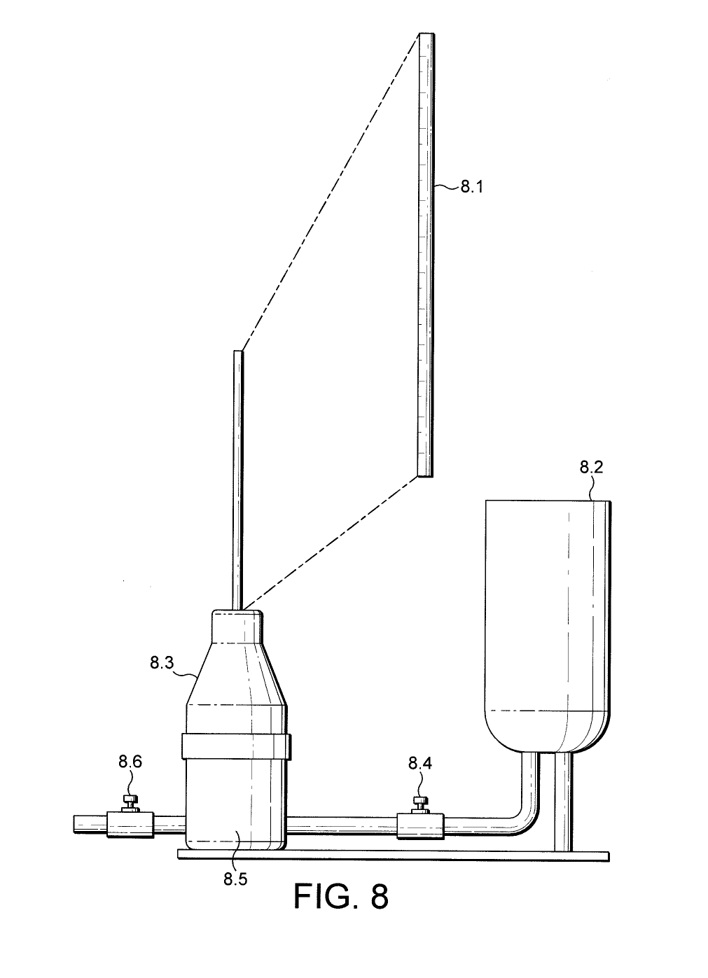

The final instant beverage granules may resemble a typical freeze-dried coffee texture. However, upon reconstitution in liquid, typically hot water, the present granules exhibit a crema volume superior to known products. For instance, 5 g of the present granules reconstituted in 200 mL of water provides a crema volume of at least 3 mL. The amount of crema produced can be measured with a simple device (FIG. 8) consisting of a reconstitution vessel connected to a water reservoir, which is initially blocked off with a valve. After reconstituting, the reconstitution vessel is closed with a special lid that ends in a scaled capillary. The valve between the reconstitution vessel and the water reservoir is then opened and the water (standard tap water of any temperature) pushes the reconstituted beverage upwards into the capillary, thus facilitating the reading of the crema volume.

The instant beverage powder which may be obtained by the present method may be a coffee powder, or powders of coffee with chicory, cereal, dairy or non-dairy creamer, cocoa powder, chocolate powder or malted beverage powder. The instant beverage powder may be mixed with any other ingredient suitable for inclusion into a beverage, e.g. a coffee powder of the invention may be mixed with a creamer and/or a sweetener to produce a coffee mix suitable for preparing e.g. café latte, cappuccino or the like.

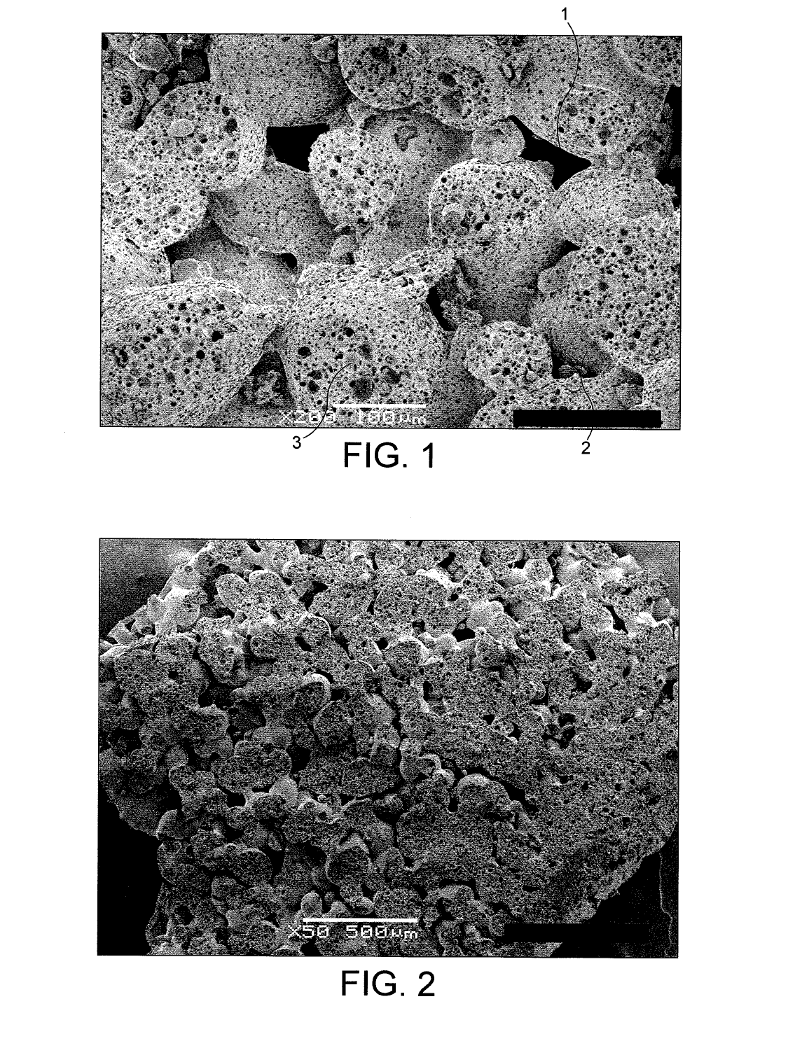

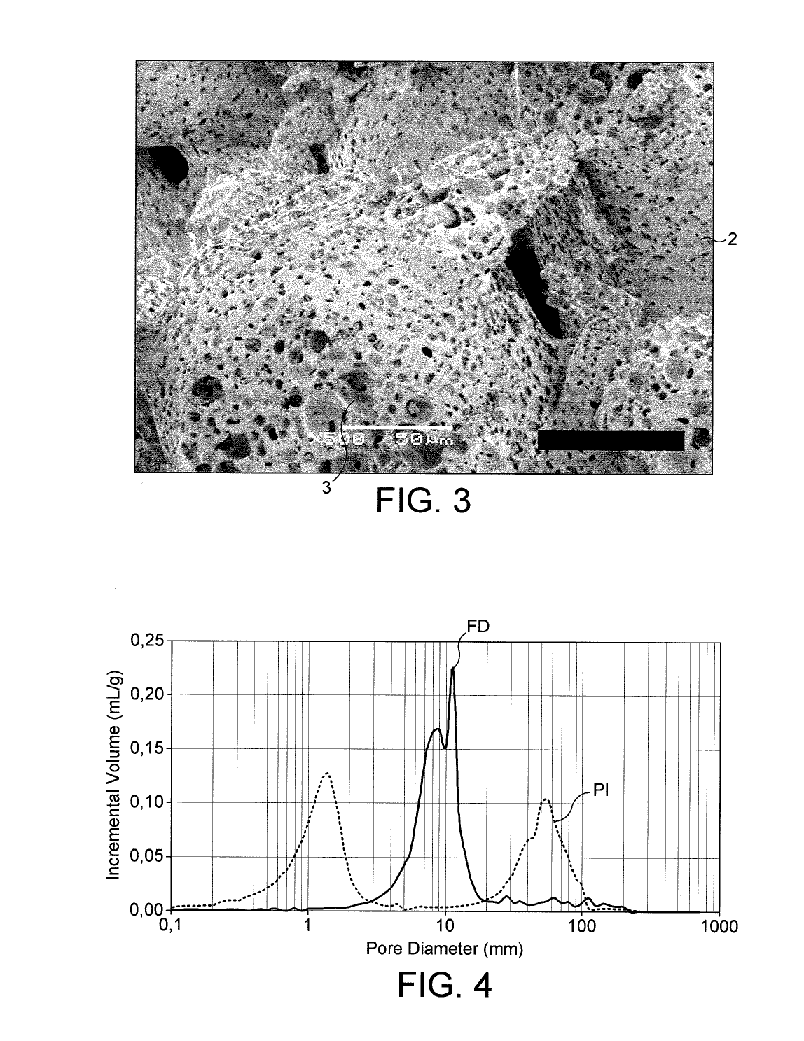

Sintered granules of the present invention are represented in FIGS. 1 to 3. FIG. 2 represents a granule according to the present invention wherein the initial powder particles are discernible. FIG. 1 is a magnified SEM image showing the interparticle voids (1) between the base powder particles, the ice crystal sublimation voids (2) occurring upon freeze-drying and the closed pores (3) resulting from the initial base powder porosity. These are also clear from FIG. 3 which is a further magnified SEM image of the present granules.

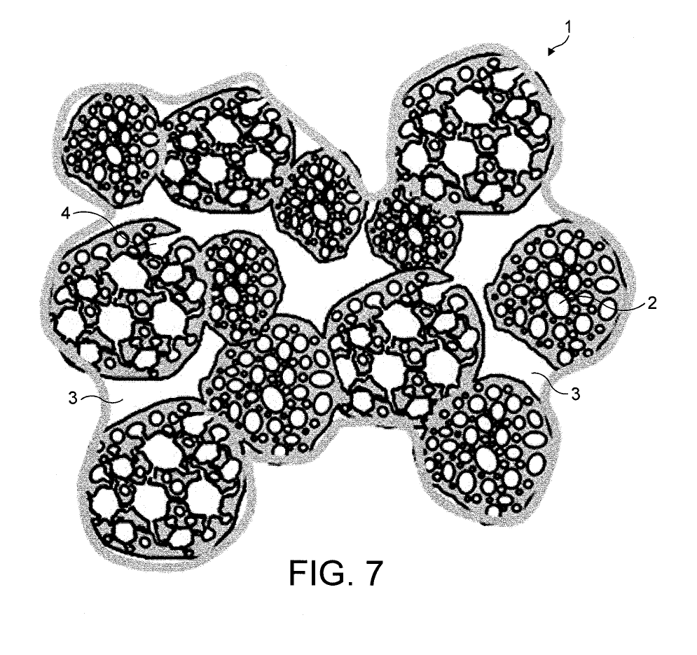

Referring to FIG. 7, it can be seen that the granules of the present invention (1) comprise closed pores (2), open pores with an opening diameter of less than 2 micrometres (4) and open pores with an opening greater than 2 micrometres (3). Furthermore, the granules of the present invention also comprise ice sublimation voids which are the result of freeze-drying a cold sintered cake.

Upon reconstitution in a liquid, the granules of the invention produce foam. The granules of the invention may thus be further defined by their foaming porosity.

Foaming porosity is a measure of the porosity which contributes to foaming and characterises the potential foaming ability of the powder of the invention. Indeed, open pores (3) will not contribute to the foaming as much, or even in some cases not at all compared to closed pores (2). Pores with opening diameter of less than 2 micrometres (4) may also contribute to foam since the capillary pressure in these pores is greater than the ambient pressure and this may enable foam formation. In the present invention, the foaming porosity is obtained by including closed pores (2) and open pores having an opening diameter of less than 2 micrometres (4).

Thus, for the purpose of measuring the foaming porosity, only closed pores (2) as well as open pores (4) having an opening diameter of less than 2 micrometres are taken into account as these are considered to contribute to foaming. The foaming porosity is obtained by the ratio of the volume of pores contributing to foaming over the volume of the aggregate excluding the volume of open pores having an opening diameter above 2 micrometres. This can be measured by mercury porosimetry or X-ray tomography.

The foaming porosity of the present sintered powders, similarly to the porous powders prior to sintering, is at least 35%, such as at least 40% or at least 50%. Preferably, the foaming porosity is between 35 and 85%, more preferably between 40 and 80%, even more preferably between 40 and 75%, even more preferably between 45 and 70%, most preferably between 45 and 65%.

Thus, a sintered instant beverage powder having a foaming porosity of at least 35%, wherein the powder comprises ice sublimation voids is part of the present invention. Similarly to the porous spray-frozen powder, the sintered powder preferably has an ice crystal pore volume of less than 2.5 mL/g, preferably less than 2.0 mL/g.

The ice sublimation voids present in the sintered powders have a dimension of less than 3 micrometres, preferably between 0.1 and 3 micrometres.

According to the invention, the sintered powders have an average closed pore diameter D₅₀ of less than 80 micrometres. Preferably the pores have an average diameter D₅₀ of less than 60 micrometres, more preferably less than micrometres, even more preferably less than 40 micrometres, even more preferably less than 30 micrometres, most preferably less than 25 micrometres. The pore size distribution is based on the void space distribution.

Another characteristic of the sintered powders of the invention is their open pores (3). These open pores form the channels for liquid penetration into the powders of the invention. The larger the volume and size of the open pores, the higher the liquid penetration and the better the dissolution. Thus, the powders of the invention may be characterised by their “open pore volume” which provides an estimation of the ability to dissolve the powder of the invention. In order to measure the open pore volume per gram of powder, the volume of the interstices having an opening diameter between 1 and 500 micrometres is taken into account. This can be measured by mercury porosimetry.

The present sintered powders are characterised by an open pore volume of less than 3 mL/g. Preferably, the open pore volume is between 0.5 and 2.5 mL/g, more preferably between 0.7 and 2.0 mL/g.

It has also been found by the present invention that another factor influencing the dissolution and the foam volumes obtained upon reconstitution is the size distribution of the pores, i.e. of the internal voids (2) and the open pores having an opening of less than 2 micrometres (4).

The pore size distribution of the sintered powders may be characterised by a distribution span factor n of less than 4, preferably less than 3, more preferably less than 2, most preferably less than 1. The distribution span factor is obtained by X-ray tomography as described above in relation to the porous powders used in the sintering process.

The sintered beverage powder preferably has a tapped density between 100-300 g/L.

The present invention also provides a cold-sintered instant beverage powder comprising ice crystal sublimation voids throughout the volume of the powder particles.

The present sintered powders may be distinguished from regular freeze-dried powders by their pore diameter distribution. Indeed FIG. 4 shows the pore size distribution of commercial freeze dried coffee (FD). The pores with size from 1 to 40 micrometres are formed by ice crystal sublimation.

For the product of invention (PI) coffee has a pore size distribution where two peaks are apparent. The pores with sizes less than 3 micrometres are formed by ice crystal sublimation. The pores with sizes from 10 to 500 micrometres are formed during sintering process, due to interparticle packing or interparticle voids.

A method for the preparation of an instant beverage comprising the step of reconstituting a sintered instant beverage powder as described above in a liquid also falls under the present invention.

The beverage is preferably a coffee, or a coffee with chicory, cereal, dairy or non-dairy creamer, a cocoa, a chocolate or a malted beverage. Most preferably, the liquid used to reconstitute the present granules is hot water, but it may also be milk, juice, cold water etc. depending on the desired final beverage.

The present invention is further illustrated by means of the following non-limiting examples.

### EXAMPLES

### Example 1

### Mercury Porosimetry to Evaluate Foaming Porosity, Particle Porosity and Open Pore Volume of a Sintered Powder According to the Present Invention

AutoPore IV 9520 is used for the structure evaluation (Micromeritics Inc. Norcrose, Ga., USA). The operation pressure for Hg intrusion was from 0.4 psia to 9000 psia (with low pressure from 0.4 psia to 40 psia and high pressure port from 20 to 9000 psia). The pore diameter under this pressure is ranged from 500 to 0.01 um. The data reported in this note will be pore volume (ml/g) at different pore diameter (um).

About 0.1 to 0.4 g of sample is precisely weighted and packed in a penetrometer (volume 3.5 ml, neck or capillary stem diameter 0.3 mm and stem volume of 0.5 ml).

After the penetrometer is inserted to the lower pressure port, sample is evacuated at 1.1 psia/min, then switch to a medium rate at 0.5 psia and a fast rate at 900 μm Hg. The evacuating target is 60 μm Hg. After reaching the target, the evacuation is continued for 5 min before Hg is filled in.

The measurement is conducted in set-time equilibration. That is, the pressure points at which data are to be taken and the elapsed time at that pressure in the set-time equilibration (10 sec) mode. Roughly 140 data points are collected at the pressure ranges.

The bulk volume of the granulate is obtained from the initial volume of mercury and the sample holder. The volume of the open pores with opening diameter greater than 2 micrometers (3) is obtained after intrusion with mercury up to a diameter of 2 micrometer. Subtraction of this volume from the bulk volume of the granulate gives the new volume of the granulate which comprises the closed pores (2), open pores with opening diameters less than 2 micrometers (4) and the volume of the coffee matrix. The volume of the closed pores, open pores with opening larger than 2 micrometers in the granulate is obtained by subtracting the volume of the coffee matrix from the new volume of the granulate. The volume of the coffee matrix is obtained from the weight of the sample and coffee matrix density. The foaming porosity is the ratio of the volume of closed pores and open pores having an opening diameter of less than 2 micrometer over the new volume of the granulate.

The particle porosity of the precursor powder may be measured using the method as described in U.S. 60/976,229.

The volume of open pores per gram of product in the diameter range 1 to 500 micrometres gives the “open pore volume”.

### Determination of the Internal Structure of Coffee Particles by Microcomputed X-Ray Tomography

X-ray tomography scans are performed with a 1172 Skyscan MCT (Antwerpen, Belgium) with a X-ray beam of 80 kV and 100 uA. Scans are performed with the Skyscan software (version 1.5 (build 0) A (Hamamatsu 10 Mp camera), reconstruction with the Skyscan recon software (version 1.4.4) and 3D image analysis with CTAn software (version 1.7.0.3, 64-bit).

To obtain a pixel size of 1 um, the camera is set up at 4000×2096 pixels and samples were placed in the Far position. Exposure time is 2356 ms. Scan is performed over 180°, the rotation step is 0.3° and the frame averaging is 4.

The reconstruction of the dataset is performed over 800 slices in average, with the settings contrast at 0-0.25. Smoothing and ring artifact reduction are set up at 1 and 10, respectively.

3D image analyses are performed on the 1 um per pixel datasets. The analysis is performed in two steps: a first step to select the region of interest in the granulate to be analysed by excluding the open pores with opening greater than 2 micrometers, the second step to obtain the distribution of the porosity in the selected region of interest. The foaming porosity value obtained by this technique matches closely that obtained by mercury porosimetry.

### Selection of Volume of Interest

The images of 1 um per pixel resolution are segmented at 30-255, cleaned by removing any single spots smaller than pixels, and then dilated by mathematical morphology (radius of 3 pixels). The selection of the volume of interest is performed through the shrink-wrap function, and then this volume is eroded by mathematical morphology (radius of 3 pixels) to adjust to the surface of the particles.

### Void Space Distribution in the Region of Interest:

The images are reloaded and segmented at 40-255. The foaming porosity is then calculated as the ratio of the volume of pores out of the volume of region of interest. The structure separation gives the pores size distribution.

The volume of open pores per gram of product in the diameter range less than 3 micrometres gives volume opened up by the ice crystal. This is referred to as the ice crystals pore volume. A preferential range between 0.1 and 3 micrometers may also be considered.

### Example 2a

### Preparation of the Porous Base Powder

1. Nitrogen gas was added to concentrated coffee comprised of an 85% Arabica/15% Robusta blend, with solids content above of 55% by means of a sparging device distributing the nitrogen homogenously.
2. The nitrogen addition rate was 2.2 litres of nitrogen per kg of coffee solid.
3. The gas/extract mixture was passed through a high-shear mixer to ensure a homogeneous dispersion of nitrogen bubbles as well as a reduction in the bubble size.
4. The foamed extract immediately passed through a heat exchanger to cool the extract down to approximately 27° C.
5. The foamed extract then entered a high pressure pump and was compressed to 135 bar.
6. The extract was atomised at 135 bar with a single fluid swirl nozzle.
7. The frozen base powder was used to produce a freeze dried product with a porous structure.

The dried base powder produced a crema volume of 7.5 ml. The dried base powder had a D₅₀ particle size of 218 microns and a tapped density of 334 g/L.

### Example 2b

### Preparation of a Porous Base Powder

1. Nitrogen gas was added to concentrated coffee comprised of a 90% Arabica/10% Robusta blend, with solids content above 55% by means of a sparging device distributing the nitrogen homogeously.
2. The nitrogen addition rate was 2.2 liters of nitrogen per kg of coffee solid.
3. The gas/extract mixture was passed through a high-shear mixer to ensure a homogeneous dispersion of nitrogen bubbles as well as a reduction in the bubble size.
4. The foamed extract immediately passed through a heat exchanger to cool the extract down to approximately 27° C.
5. The foamed extract then entered a high pressure pump and was compressed to 100 bar.
7. The extract was atomised at 100 bar with a single fluid swirl nozzle.
8. The frozen base powder was used to produce a freeze dried product with a porous structure.

The dried base powder produced a crema volume of 6.1 ml. The dried base powder had a D₅₀ particle size of 226 micron and a tapped density of 481 g/L.

### Example 2c

### Preparation of a Porous Base Powder

1. Nitrogen gas was added to concentrated coffee comprised of an 85% Arabica/15% Robusta blend, with solids content above of 52% by means of a sparging device distributing the nitrogen homogeneously.
2. The nitrogen addition rate was 2.9 litres of nitrogen per kg of coffee solid.
3. The gas/extract mixture was passed through a high-shear mixer to ensure a homogeneous dispersion of nitrogen bubbles as well as a reduction in the bubble size.
4. The foamed extract immediately passed through a heat exchanger to cool the extract down to approximately 36° C.
5. The foamed extract then entered a high pressure pump and was compressed to 135 bar.
7. The extract was atomised at 135 bar with a single fluid swirl nozzle.
8. The frozen base powder was used to produce a freeze dried product with a porous structure.

The dried base powder produced a crema volume of 6.8 ml. The dried base powder had a D₅₀ particle size of 177 micron and a tapped density of 545 g/L.

### Example 2d

### Preparation of a Porous Base Powder

1. Nitrogen gas was added to coffee liquor comprised of an 85% Arabica/15% Robusta blend using extraction method A, with solids content above of 59% by the means of a sparging device distributing the nitrogen homogenously.
2. The nitrogen addition rate was 2.2 litres of nitrogen per kg of coffee solid.
3. The gas/extract mixture was passed through a high-shear mixer to ensure a homogeneous dispersion of nitrogen bubbles as well as a reduction in the bubble size.
4. The foamed extract immediately passed through a heat exchanger to cool the extract down to approximately 38° C.
5. The foamed extract then entered a high pressure pump and was compressed to 155 bar.
7. The extract was atomised at 155 bar with a single fluid swirl nozzle.
8. The frozen base powder was used to produce a freeze dried product with a porous structure.

The dried base powder produced a crema volume of 7.2 ml. The dried base powder had a D₅₀ particle size of 113 micron and a tapped density of 557 g/L.

### Example 3a

### Preparation of Instant Beverage Granules

A (porous spray-frozen powder) precursor was formed into thin cakes using a manual preparation method, that is, hand filling the precursor into a rectangular pan of dimensions 410 mm×610 mm×20 mm.

The cakes were manually transferred onto the stainless steel sintering belt located in a −40° C. ambient environment.

The cakes on the belt were conveyed into the heated sintering zone with air temperature of −14° C. for a residence time of 18 minutes.

After sintering, the cakes entered the cooling zone, were removed from the belt, and subsequently ground to form a freeze-dried looking texture, of particle size range from 0.6 to 3.2 mm.

All the above steps took place in the −40° C. cold room environment.

After texturising, the ground frozen product was freeze-dried in a batch vacuum chamber to produce the final dried product. The final moisture content of the dried product was 1.9%.

The final product had the following properties:

a. Tapped density=195 g/L
b. Crema volume=4.1 mL

### Example 3b

### Preparation of Instant Beverage Granules

A (porous spray-frozen powder) precursor produced by Example 2b was distributed into a continuous bed on a stainless steel conveyor belt in a −40C ambient environment. The bed depth was approximately 10 mm.

The bed was conveyed into the heated sintering zone with air temperature of −11° C. for a residence time of 20 minutes.

After sintering, the bed entered the cooling zone and was subsequently ground to form a freeze-dried looking texture of particle size range from 0.6 to 3.2 mm.

All the above steps took place in the −40° C. cold room environment.

After texturising, the ground frozen product was freeze-dried in a batch vacuum chamber to produce the final dried product.

The final moisture content of the dried product was 0.6%.

The final product had the following properties:

a. Tapped density=232 g/L
b. Crema volume=6.9 mL

1. Method for the preparation of an instant beverage powder comprising the steps of
providing a porous base powder;
sintering the base powder at a temperature below 0° C. to form a sintered cake
grinding the sintered cake to provide a powder; and
freeze-drying the powder to provide the instant beverage powder.

2. Method according to claim 1, wherein the instant beverage powder is in the form of granules.

3. Method according to claim 1, wherein the base powder is spray-frozen.

4. Method according to claim 1, wherein the porous base powder has a particle porosity of at least 35%.

5. Method according to claim 1, wherein the porous base powder has an ice crystal pore volume of less than 2.5 mL/g, and an ice crystal pore size of less than 3 micrometres.

6. Method according to claim 1, wherein the porous base powder is maintained at a temperature of below 0° C. prior to sintering.

7. Method according to claim 1, wherein the sintering performed in a sintering zone through which a conveyer belt carrying the base powder runs.

8. Method according to claim 7, wherein the sintering zone is at a temperature of above −30° C.

9. Method according to claim 1, wherein the sintered cake is passed through a cooling zone prior to grinding.

10. Method according to claim 9, wherein the cooling zone is at a temperature below the sintering zone temperature.

11. Method according to claim 10, wherein the cooling zone is at a temperature of below −10° C.

12. Method according to claim 1, wherein the instant beverage powder has particles having a size greater than 0.5 mm, preferably less than 4 mm.

13. Method according to claim 1, wherein the moisture content of the instant drink powder after freeze-drying is 0.5-5%.

14. Method according to claim 1, wherein all steps are performed in a cold room environment at below 0° C.

15. Method according to claim 1, wherein the instant beverage powder is selected from the group consisting of a coffee powder, and powders of coffee with chicory, cereal, dairy and non-dairy creamer, cocoa powder, chocolate powder and malted beverage powder.

16. Instant beverage powder obtained by a the steps of
providing a porous base powder;
sintering the base powder at a temperature below 0° C. to form a sintered cake;
grinding the sintered cake to obtain a powder; and
freeze-drying the powder to obtain the instant beverage powder.

17. A porous spray-frozen powder comprising a particle porosity of at least 35%, an ice crystal pore volume of less than 2.5 mL/g and an ice crystal pore size of less than 3 micrometres.

18. Powder according to claim 17, wherein the ice crystal pore volume is less than 2.0 mL/g.

19. Powder according to claim 17, wherein the ice crystal pore size is between 0.1 and 3 micrometres.

20. Powder according to claim 17, comprising an average pore size diameter D₅₀ of less than 40 micrometres.

21. Powder according to claim 17, comprising a distribution span factor n of less than 4.

22. Powder according to claim 17, wherein the particle porosity is between 35% and 85%.

23. Powder according to claim 17, having a tapped density of between 150-650 g/L.

24. Powder according to claim 17, which is freeze-dried.

25. Powder according to claim 24, which is an instant beverage powder.

26. Instant beverage powder obtainable by cold sintering a porous spray-frozen powder comprising a particle porosity of at least 35%, an ice crystal pore volume of less than 2.5 mL/g and an ice crystal pore size of less than 3 micrometres.

27. Sintered instant beverage powder having a foaming porosity of at least 35%, the powder comprises comprising ice sublimation voids.

28. Instant beverage powder according to claim 27, which has an ice crystal pore volume of less than 2.5 mL/g.

29. Instant beverage powder according to claim 27, wherein the ice sublimation voids have a dimension of less than 3 micrometres.

30. Instant beverage powder according to claim 27, comprising an average pore size diameter of less than 40 micrometres.

31. Instant beverage powder according to claim 27, having an open pore volume between 0.5-2.5 mL/g.

32. Instant beverage powder according to claim 27, comprising a distribution span factor n of less than 4.

33. Instant beverage powder according to claim 27, having a tapped density between 100-300 g/L.

34. Cold-sintered instant beverage powder comprising ice crystal sublimation voids throughout the volume of the powder particles.

35. Method for the preparation of an instant beverage comprising the step of reconstituting an instant beverage powder according to having a foaming porosity of at least 35%, the powder comprising ice sublimation voids in a liquid.

36. Method according to claim 35, wherein the instant beverage is selected from the group consisting of a coffee, a coffee with chicory, cereal, dairy and non-dairy creamer, a cocoa, chocolate and malted beverage.

37. Method according to claim 35, wherein the liquid is hot water.

38. Method according to claim 35, wherein at least 3 mL of crema are produced upon reconstitution in a liquid.
